(19) United States
(12) Patent Application Publication
(10) Pub. No.: US 2005/0184034 A1
(43) Pub. Date: Aug. 25, 2005

(54) Method for using a microwave source for reactive atom-plasma processing

(75) Inventor: Jeffrey W. Carr, Livermore, CA (US)

Correspondence Address: FLIESLER MEYER, LLP, FOUR EMBARCADERO CENTER, SUITE 400, SAN FRANCISCO, CA, 94111, US

(73) Assignee: Rapt Industries, Inc., Livermore, CA (US)

(21) Appl. No.: 11/089,966

(22) Filed: Mar. 25, 2005

Related U.S. Application Data
(62) Division of application No. 10/383,478, filed on Mar. 7, 2003.

(51) Int. Cl. B23K 9/00

(52) U.S. Cl. 219/121.48

(57) ABSTRACT

Reactive atom plasma processing (RAP) can be used to shape, polish, planarize, and clean surfaces of difficult materials with minimal subsurface damage. An improved RAP device utilizes a microwave-induced plasma (MIP) source instead of a conventional ICP torch to modify these surfaces. The use of MIP provides for a smaller footprint, finer detail, simpler and enhanced movement capabilities, lower heat load, fewer shielding requirements, and cheaper construction and operation than ICP. This description is not intended to be a complete description of, or limit the scope of, the invention. Other features, aspects, and objects of the invention can be obtained from a review of the specification, the figures, and the claims.

### CLAIM OF PRIORITY

This application claims priority from U.S. patent application Ser. No. 10/383,478, entitled “Apparatus and Method for Using a Microwave Source for Reactive Atom Plasma Processing” by Jeffrey W. Carr, filed Mar. 7, 2003 (Attorney Docket No. CARR-01001US0), incorporated herein by reference.

### FIELD OF INVENTION

The field of the invention relates to the modification of surfaces using a gas plasma.

### BACKGROUND

U.S. patent application Ser. No. 10/008,236 discloses the use of reactive atom plasma processing to modify surfaces of difficult materials with minimal subsurface damage. The apparatus and methods of various embodiments use a conventional inductively-coupled plasma (ICP) torch. The workpiece and plasma torch are moved with respect to each other, such as by translating and/or rotating the workpiece, the plasma, or both. The plasma discharge from the ICP torch can be used to shape, planarize, polish, clean and/or deposit material on the surface of the workpiece, as well as to thin the workpiece. The processing causes no damage to the workpiece underneath the surface, and can involve removing material from, and/or redistributing material on, the surface of the workpiece.

FIG. 1 shows one embodiment of a RAP system as disclosed in prior application Ser. No. 10/008,236. FIG. 1 shows an ICP torch in a plasma box 106. The torch consists of an inner tube 134, an outer tube 138, and an intermediate tube 136. The inner tube 134 has a gas inlet 100 for receiving a stream of precursor gas 142 from the mass flow controller 118. The gas inlet 100 can also be used for receiving a depositional precursor gas stream 140, or a material (as particles or in solution) to be deposited on the surface of a workpiece. The intermediate tube 136 has a gas inlet 102 for receiving an auxiliary gas from the flow controller 118. The outer tube 138 has a gas inlet 104 for receiving a plasma gas from the mass flow controller 118. The mass flow controller 118 receives the necessary gasses from a number of gas supplies 120, 122, 124, 126, and controls the amount and rate of gasses passed to the respective tube of the ICP torch. The coils generate a plasma discharge within the torch 108, and this discharge can be used to, for example, shape or polish a workpiece 110 located on a chuck 112 in the workpiece box 114. In this embodiment, the plasma box 106 and workpiece box 114 are separate, allowing the plasma discharge 108 and/or torch to pass at least partially between the plasma 106 box and the workpiece box 114. The workpiece box 114 has an exhaust 132 for carrying away any process gases or products resulting from, for example, the interaction of the plasma discharge 108 and the workpiece 110. In other embodiments, there may not be separate boxes for the plasma torch and the workpiece.

The torch itself can be seen in greater detail in FIG. 2. An induction coil 140 surrounds the outer tube 138 of the torch near the plasma discharge 144. Current from the RF power supply flows through the coil 140 around the end of the torch. This energy is coupled into the plasma. Also shown are the excitation zones 142, into which the reactive precursor is injected, and the plasma envelop 146, which can be for example a sheath of argon gas.

In a system using a conventional ICP torch for reactive atom plasma processing (RAP), the current from an RF generator, such as a 13.56 MHz RF generator, flows through a two to four turn copper load coil around the top of the torch. The energy is coupled into the plasma through an annular “skin region” that is located on the outer edge of the plasma nearest the load coil. The plasma can be supported in a quartz tube by the plasma gas, which can be introduced tangentially to form a stabilizing vortex. The plasma has its lowest density along the central axis and the droplets or gas easily penetrate the discharge. For analytical applications, the sample is introduced in a solution. As the droplets travel through the plasma they becomes progressively desolvated, atomized, excited, and ionized.

For RAP applications, a standard, commercially-available three tube torch can be used, such as one having three concentric tubes as discussed above. The outer tube can handle the bulk of the plasma gas, while the inner tube can be used to inject the reactive precursor. Energy is be coupled into the discharge in an annular region inside the torch. As a result of this coupling zone and the ensuing temperature gradient, a simple way to introduce the reactive gas, or a material to be deposited, is through the center. The reactive gas can also be mixed with the plasma gas to provide a wider footprint (tool size), although the quartz tube can erode under this configuration.

The use of a conventional ICP torch can come with certain limitations and attributes, however, that may be less than desirable for specific applications. For instance, the footprint of an ICP torch maybe too large for fine-scale modifications. The flow of host gas for an ICP torch is a source of expense, and it would be more cost effective to use a lower flow rate in order to reduce the cost-per-part processed by the system. A device using an ICP torch can be somewhat bulky, limiting the mobility and ease-of-use of the device. Due to its size, the part often has to be rotated and/or translated with respect to the torch. An ICP torch can also place a relatively high heat load on the part being processed, which may be unacceptable for certain workpieces and materials.

An ICP torch requires a certain amount of shielding, which adds to the cost of the device. A plasma box, which itself can be bulky and add additional expense, is often used to shield an operator from radio frequency energy generated during a process, and/or from UV light produced by a plasma. The parts that make up the ICP torch itself are also relatively expensive, and are not highly-available.

One area of technology that has been studied with respect to plasma sources, particularly in the 1980's, involves the use of atmospheric pressure microwave induced plasmas. A microwave-induced plasma (MIP) typically consists of a quartz tube surrounded by a microwave cavity or waveguide. A microwave source produces microwaves that fill the cavity and cause the electrons in the plasma support gas to oscillate. These oscillating electrons collide with other atoms in the flowing gas to create and maintain a high-temperature plasma.

The amount of research into MIP has been slight when compared to the amount of activity in the field of radio frequency ICP, and is mostly focused in two areas unrelated to surface modification. The initial research activity centered on MIP as a spectroscopic source using helium as the host gas, typically directed toward applications in analytical spectroscopy. The research focused on relatively energetic helium plasmas to excite the high energy transitions of non-metals such as halogens.

Early MIP work suggested that such a plasma was unable to easily vaporize liquid samples. Not surprisingly, the most common application was as a detector for a gas chromatography. More recent research dealt with the use of MIP as a source for mass spectroscopy, or as a source for the detection of non-metals. Technical reasons for this use include the spectral interference between argon lines and the emission spectra of nonmetals. It has not been suggested or demonstrated, however, that MIP maybe useful in material modification.

### BRIEF SUMMARY

Systems and methods in accordance with the present invention overcome deficiencies and obstacles in the prior art to provide improved reactive atom plasma processing for certain applications. A system and method in accordance with the present invention can modify the surface of a workpiece using a microwave-induced plasma torch configured to modify the surface of a workpiece using a reactive atom plasma process. A translator can move the microwave-induced plasma torch with respect to the workpiece, such as by translating and/or rotating the torch with respect to the workpiece according to a specified pattern. The microwave-induced plasma torch can operate at atmospheric pressure, can have a footprint between about 0.5 mm and about 10 mm, and can operate at a power ranging from about 35 W to above 3 kW.

A gas source can direct a flow of process gas into the microwave induced plasma torch, which can include two concentric tubes to receive the process gasses. A flow regulator can maintain the flow of process gas between about 0.5 I/min and about 14 I/min. A microwave cavity can surround at least a portion of the microwave-induced plasma torch, which can receive microwaves from a microwave source in order to excite atoms in the plasma. A helical insert can be placed between the two concentric tubes in order to hold the spacing of the tubes, as well as to increase the velocity of the gasses flowing through the tubes and cool the tubes themselves. An external power source, such as a 2.45 GHz power source, can be used to supply energy to the microwave cavity. The cavity itself can be tunable, such as through use of a moveable plunger. A gas sheath can be attached to the cavity to shield the microwave-induced plasma from the atmosphere.

Once such a system is in place, the surface of a workpiece can be modified in one-, two-, or three dimensions. The plasma can be used to remove material, redeposit material, redistribute material, and deposit additional material on the surface of the workpiece. This can allow the system to be used accomplish tasks such as cleaning, polishing, shaping, and thinning the workpiece.

Other features, aspects, and objects of the invention can be obtained from are view of the specification, the figures, and the claims.

### BRIEF DESCRIPTION OF THE FIGURES

FIG. 1 is a diagram of an ICP system as disclosed in related application Ser. No. 10/008,236.

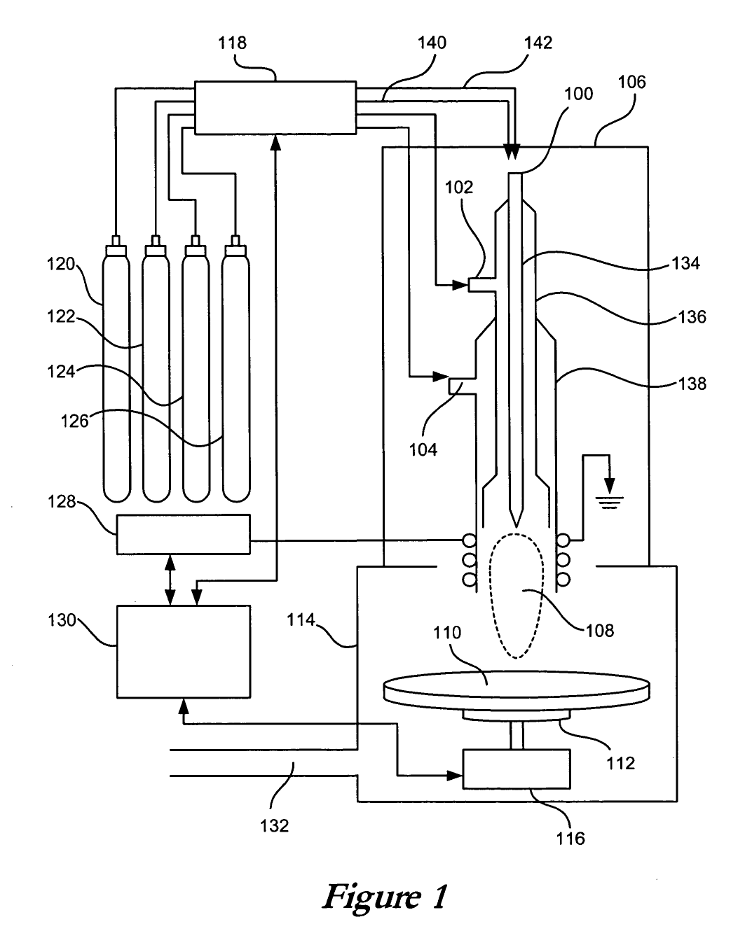

FIG. 2 is a diagram of an ICP torch that can be used with the system of FIG. 1.

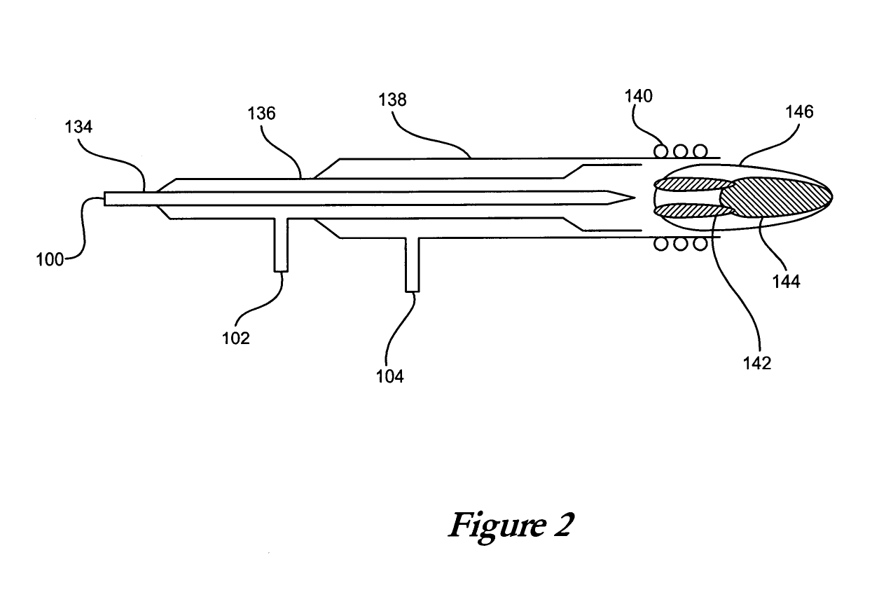

FIG. 3 is a diagram of an MIP system that can be used in accordance with one embodiment of the present invention.

FIG. 4 is a diagram of an MIP torch that can be used with the system of FIG. 3.

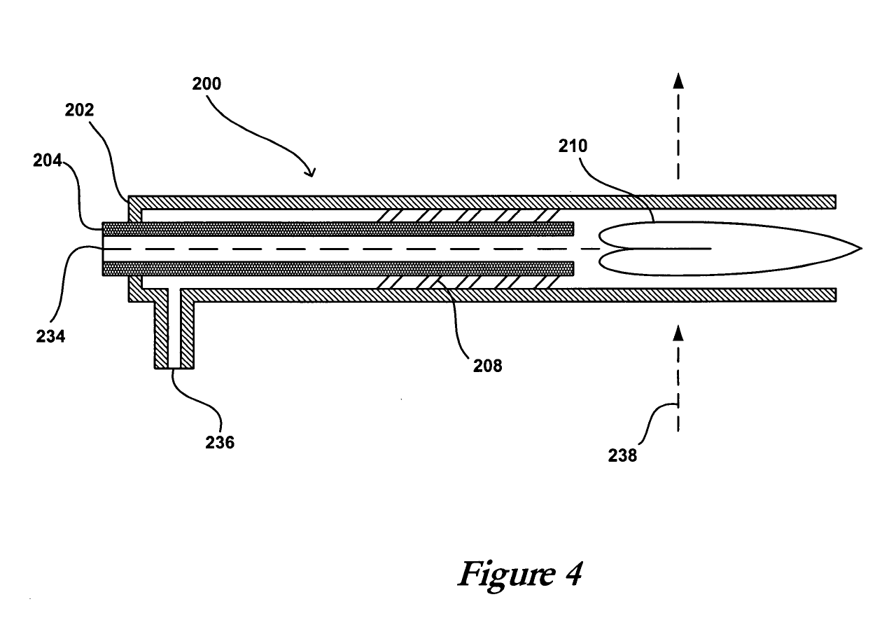

### DETAILED DESCRIPTION

A microwave-induced atmospheric pressure plasma can be an appropriate atomnization tool for several applications of a reactive atom plasma process. A microwave-induced plasma (MIP) source has proven to have a number of attributes that complement, or even surpass in some applications, the use of an ICP tool or a flame as an atomization source. Some of these advantages include a smaller footprint, which can be as low as about 0.5 mm or less, or from about 1 mm or less to about 10 mm or more, as well as a smaller and simpler device that can operate on lower flow rates of host gas and can even be run on air, nitrogen or oxygen. Flow rates for one MIP device can range between about 0.5 I/min to about 13 I/min or so, although flow rates of less than 0.5 I/min and above 13 I/min are also possible. Host gases can include, for example, Argon, Helium, nitrogen, air, CF₄, oxygen and/or hydrogen. In fact, any gas phase material or combination thereof could be used.

The plasma can be run at a very low power, such as from about 35 watts to about 3 kW. Less energy is needed to fragment the precursor than would be needed for an ICP or flame, especially if a high flow, low power helium design is selected. This can result in less heat load on the part, which is preferable for certain temperature-sensitive applications. The tuning or matching network is relatively uncomplicated, simplifying construction and lowering cost. The smaller size of both the cavity and the tuning network facilitate the translation of the MIP source, meaning there may no longer be any need to translate large parts or workpieces.

The MIP approach simplifies the mechanics needed to hold a workpiece, and can reduce the workpiece motion to a high speed rotary stage, for example. Through the use of a small atomization source and tuning network, which can be as small as 5% the size of a current ICP unit, or roughly 100 mm in diameter and 15 mm thick, for example, the source could be moved at high speed with five or six degrees of freedom. The ability to tilt and rotate the tool around its axis of curvature permits the fabrication of workpieces with steep wall angles, for example, without the need for tool shape calculations that add to the complexity of the motions. Movement of the torch over the surface of a workpiece can include the translation, rotation, tilt, and height adjustment of the torch with respect to the surface of the workpiece, for example, in order to properly modify the workpiece according to a two- or three-dimensional pattern.

Further, the atomization source is much easier to shield than a standard ICP torch, and can be operated in an open room or on the side of a building, if necessary. The simpler device can also be made cheaper and easier than an ICP torch system. An MIP can be built using the abundant and cheap supply of components for microwave ovens, for example. Like the ICP, the MIP can create an annular discharge under certain operating conditions. This provides the advantage of a stable plume of reactive atoms an a sheath of inert gas to shield the radicals from the atmosphere.

One type of cavity that can be used with systems and methods in accordance with the present invention is a Beenakker cavity. For reactive atom processing work, an MIP based on the Bennacker design or one of the many improved versions has a number of advantages. If the diameter is great enough, the plasma is annular in nature, so the sample can be injected directly into the center of the energy zone. As in the ICP design, this is beneficial because the reactive species would be oriented in a more deterministic fashion, and would be shielded from the atmosphere by the noble gas plasma.

Existing Beenakker cavities are optimized for spectroscopic emission, but serve well in a number of reactive atom plasma processing applications. Axial plasmas with central sample injection and small compact designs running on low power, as well as readily available consumer electronics, are suitable for many applications. Some of the larger, or higher power, units run above 1 kW, the same power as a standard ICP, and have flow rates as high as 13 I/min. These systems also tend to have larger torches. For example, the self-servingly named Okamoto cavity uses a two tube torch with a 10 mm OD and an 8 mm ID. When the tubes are that large, especially with helium as the plasma gas, the discharges are clearly axial.

When designing or selecting a microwave source, it is useful to set forth the important characteristics to be achieved. In one example, a primary concern is that the tool have a smaller diameter. Of secondary importance is the fact that the system should require less shielding than an ICP source. Of further importance, the cost of components making up the MIP source, as well as the operating cost, should be lower than for the ICP source.

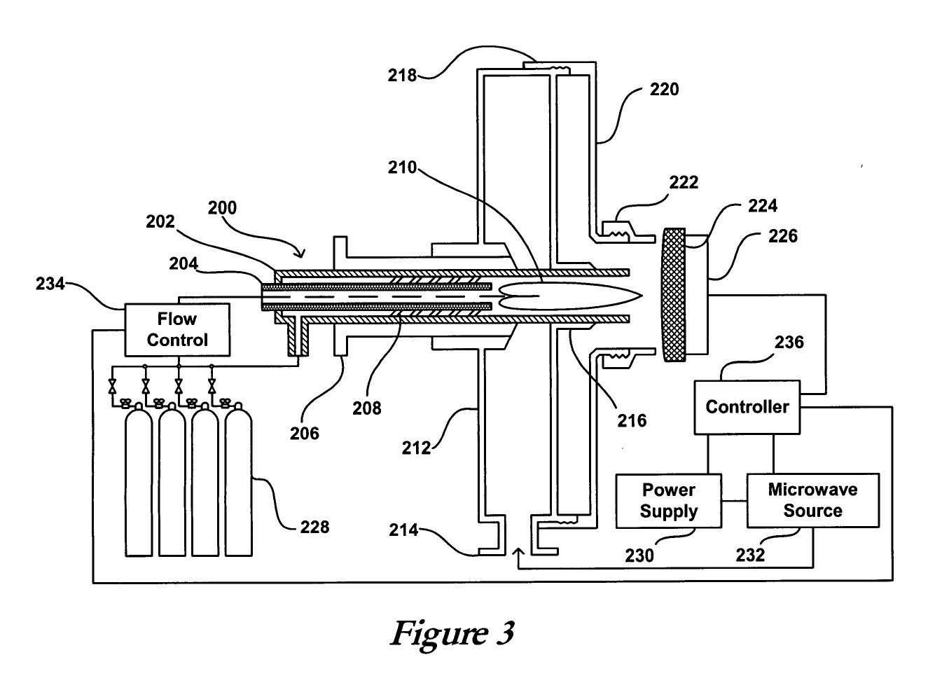

As shown in FIG. 3, the plasma can be contained in a quartz torch 200, which is distinguished from a standard analytical ICP by the use of two concentric tubes instead of three. With a large enough bore or high frequency, the plasma can be generated and the precursor injected into the center of the torch in a manner analogous to the ICP. The system can be built with a three tube torch, but there is no need for the extra tube in many applications. At 2.45 GHz, smaller tubes, such as those about 1 mm to about 2 mm or less, produce axial plasmas. The sub-millimeter plasmas can be used as small tools, but the reactive gas may need to be mixed with the main body of the plasma gas if it is to be fragmented for certain applications. To prevent erosion, the torch can be fabricated from a chemically inert material. In the case of fluoride plasmas, for example, an alumina tube can be used. The torch can be a fixed, single piece, one or two tube design, or can be made de-mountable in the manner of some ICP torches, such that the tubes are individually held and separately replaced. An advantage to a de-mountable system is that the length of the outer tube can be increased, allowing the plasma to cool down while preventing reactive radical atoms from interacting with the entrained air. The operational setting of the torch can depend on several factors, including power and reactive precursor load.

A helical insert 208 can be placed between the outer tube 202 and the inner tube 204 of the torch 200 to control tube concentricity, as well as to direct and increase the velocity of gas. The vortex flow purportedly stabilizes the system, and the high velocity aids in cooling the quartz tubes 202, 204.

The main portion of the microwave cavity 212 can be a circular or cylindrical chamber, seen here in cross section. The microwave cavity can be machined from a highly conductive material, such as copper. The energy from a 2.45 Ghz (or other appropriate) power supply 230 can be coupled into the cavity 212 through a connector 214 on one edge of the cavity. The impedance between the power cable and the cavity can be matched by any appropriate means, such as by utilizing tuning stubs along the cable.

The cavity 212 can be tuned in one embodiment by moving a hollow cylindrical plunger 206, or tuning device, into or out of the cavity 212. The quartz torch 200 is contained in the center of the tuning device 206 but does not move while the system is being tuned. Since the cavity is not cooled, purged, or evacuated in this embodiment, there is no need for a seal between the two tubes.

The torch 200 can protrude several millimeters beyond the cavity 212. This distance can be determined by the specific application, and can vary from a few millimeters to ten centimeters or more. The plasma 210 can extend well beyond the cavity 212 as well, and for many embodiments will not be quenched until the plasma is well beyond the end of the outer tube 202. However, there are situations where the plasma 210 has visibly decayed before the end of the torch 200 is reached.

An external gas sheath 220 can be used to shield the plasma 220 from the atmosphere. The sheath 220 can contribute to the longevity of the reactive species in the plasma, and can keep the atmospheric recombination products as low as practically possible. In one embodiment, the end of the sheath 220 is approximately coplanar with the open end, or tip, of the torch 200. The sheath 220 can be extended beyond the tip of the torch 200 by installing an extension tube 222 using a threaded flange at the outlet of the sheath 220. The sheath itself can be threadably attached 218 to the main cavity 212, which can allow a fine adjustment on height to be made by screwing the sheath either toward or away from the cavity 212. A supply of process gas 228 can provide process gas to both tubes 202,204 or the torch 200. In one embodiment this process gas is primarily composed of argon or helium, but can also include carbon dioxide, oxygen or nitrogen, as well as other host gasses, if the chemistry of the situation permits. Gas flows in this embodiment can be between about one and about ten liters per minute.

An MIP device may not be preferable to an ICP for all applications, however, particularly for large-scale applications. Smaller MIP devices may not have enough energy to vaporize a sufficiently large concentration of reactive gas. If the flow rates are low, the limitation on power, about 300 watts for the simpler MIP cavities, can result in a lower maximum concentration of reactive gas. The MIP also may not planarize over large areas due to the lower operating temperature, and the proper conditions to set up a large equilibrium environment may not be present. For many applications, the ICP may remain the tool of choice due to its inherently larger footprint as well as those properties discussed above.

A chuck 226 can be used to hold the workpiece 224 to be modified. The chuck 226 can be in communication with a translation stage, which is adapted to translate and/or rotate the workpiece 224 on the chuck 226 with respect to the plasma discharge 210. The translation stage can be in communication with a computer control system, such as maybe programmed to provide the necessary information or control to the translation stage to allow the workpiece 224 to be moved along a proper path to achieve a desired modification of the workpiece. The computer control system can be in communication with the microwave power supply 232, and can provide the necessary information to any mass flow controllers or to the power supply 230 coupled to the cavity.

The system can also include a sample chamber to contain the workpiece during processing. The main components inside such a sample chamber, with the exception of the sample, can include translation stages and a chuck. The chuck can be a relatively simple vacuum system, which can be mounted to the rotary stage and connected to a pump, such as a carbon vane pump, through a rotary or other appropriate connection. The chuck can be smaller than, or equal in size to, the size of the part. If the chuck protrudes past the part, a small amount of chuck material may deposit on the edge or surface.

Devices such as rotometers, mass flow controllers, and simple on/off valves (pulsed control) can be used to meter gas flow. A system can, for example, use mass flow controllers with piezoelectric transducers to monitor gas flow on all lines as needed. A power source and control panel can be rack mounted. This can be a commercial unit useful for low pressure capacitively coupled discharges. The rack can also contain the stage controller and the electronics for the mass flow controllers.

There can be several mass flow controllers controlling gas introduction. Having several controllers in series and/or parallel with flow ranges such as from 10 l/min to 0.1 l/min can provide a variety of gas mixtures, which in turn can allow for more complicated reactive chemistry. The main gas flow, such as may contain a plasma gas, can serve to supply the discharge with a flowing stream of, for example, argon. The flow rate can be changed over a fairly wide range, such as from zero to about 100 l/min, depending on the RF power level used. If the flow is too fast, the plasma may “blow out.” A large flow rate can result in a dilution of both the reactive gas and of the energy put into the system. This could be viewed as a good or a bad thing, depending on the application. Excessive flow rates also increase the cost of the per hour gas consumables.

While FIG. 3 shows an MIP design that can be used in accordance with one embodiment of the present invention, many other designs and configurations can be implemented with similar results. The dimensions of such a design can be dictated by the choice of operating parameters. There are a number of parameters that can be specified in designing a tool for an RAP application. First, the power of a device can be from about 100 Watts to about 2,000 Watts or more, with higher power typically necessitating higher flow. A preferred range for certain devices is between about 500 Watts and about 1000 Watts. A frequency of 2.45 GHz is appropriate for such devices, although frequencies near 2.45 GHz, above 2.45 GHz, and below 2.45 GHz may also be appropriate.

The main gas flow rate in this design is from about 2 l/min to about 10 l/min, specifically for argon or helium, although flow rates below about 2 l/min and above about 10 l/min may also be appropriate. In certain devices, a main gas flow rate of about 5 l/min is used. The inner diameter of the cavity in this design is about 3 mm, although the cavity can be at least as large as 10 mm. One such device has an inner diameter of about 5 mm and an outer diameter of about 6 mm. The length of the cavity in this design is a fraction of the wavelength. A 2.45 GHz frequency translates into a wavelength of 1.22 meters. This design can be significantly smaller than that, such as on the order to about 6 cm internally. Smaller tubes can generate axial plasmas instead of cylindrical plasmas, and may not be useful for many applications as the reactive precursor in these instances can be mixed with the main plasma gas.

To a certain degree, fixing the tube diameter has little effect on the overall cavity design. A final system can include an insert wherein the central portion of the cavity is replaceable in order to accommodate different plasma sizes. A more narrow tube can result in an axial plasma with a sub-millimeter footprint. The design can be a single tube design, with the gasses being premixed before introduction into the discharge region. The tube can be manufactured out of a chemically resistant material, such as alumina for fluorine plasmas.

Chemistry

A reactive atom plasma process in accordance with embodiments of the present invention is based, at least in part, on the reactive chemistry of atomic radicals formed by the interaction of a non-reactive precursor chemical with a plasma. In one such process, the atomic radicals formed by the decomposition of a non-reactive precursor interact with material on the surface of a part being shaped. The surface material is transformed to a gaseous reaction product and leaves the surface. A variety of materials can be processed using different chemical precursors and different plasma compositions. The products of the surface reaction in this process must be a gas under the conditions of the plasma exposure for material removal to take place. If not, a surface reaction residue may build up on the surface which will impede further etching. The reactive precursor chemical can be introduced to the plasma as a gas, liquid, or solid. Liquids can be aspirated into the plasma and fine powders can be nebulized by mixing with a gas before introduction to the plasma.

A small torch erosion problem may exist due to a minor portion of the precursor not entering the central zone but instead going around the outside of the plasma. An increase in skin depth (i.e. a thicker energy coupling zone) can constrict the central channel, possibly restricting the precursor flow and allowing some to escape to the periphery. One of the advantages of systems in accordance with the present invention is that there is little to no electrode or nozzle erosion.

Precision Shaping

Using conditions such as those described above, it is possible to get a stable, predictable, reproducible distribution of reactive species that is roughly Gaussian in nature, although other distributions are possible and may be appropriate for certain applications. For many applications, it may only be desirable that the distribution be radially symmetric. For example, an 18 mm inner diameter torch may have a spread of about 30 mm. As the exposure time is increased or decreased, a hole can get deeper or shallower, but its width may not vary greatly. Therefore, the tool shape produced by the plasma system can be extremely shallow and broad, which can relax the requirements for precision X-Y positioning of the tool or the part.

An important factor in this process is the fact that the footprint of the plasma discharge can be stable and reproducible, and dependent upon controllable parameters. Fairly similar etch rates can be produced if similar systems are run under identical conditions, and the same system can be highly reproducible from day to day. For extremely precise surfaces, the footprint of the tool may need to be measured before each removal step. It may also be possible, however, to determine the footprint as a by product of the iterative shaping process.

If any shape on the part is required, other than a Gaussian depression of various depths, it may be necessary to translate and/or rotate the torch relative to the part, although it may still be useful to translate and/or rotate the part with respect to the torch, or each with respect to the other. If the torch is lowered into the part, a depression or pit can result. If the torch translates across the part, a trench may be produced. The floor of the trench can take on the characteristics of the distribution of reactive species in the torch, and also can be determined by how closely the torch paths approach each other on subsequent passes. In such a process, a rough part can be measured for which a fairly accurate estimate of the footprint is known, such as from previous experiments. The final desired part shape maybe known, and a pathway for the tool can be calculated to get the final shape from all of the input variables, including such input variables as initial part shape, plasma conditions, dwell time, and removal behavior of the workpiece material. When completed, the part shape could be accurately measured and compared with the desired shape. The difference may be the error in the assumption of the footprint shape. For uniform material removal in certain applications, the speed of the torch across the surface may need to be constant. For some applications it maybe necessary to vary all parameters simultaneously including tool position, part position, gas flow rate, gas flow composition and excitation energy.

Deposition

One process that can be used in accordance with embodiments of the present invention utilizes the plasma to put down a coating on the surface of the workpiece. The plasma can also be used to subtly alter the chemistry of the surface. A slight addition of oxygen in the plasma at the beginning of the process, for example, can clean any organic material from the surface. Reactive surfaces can be created for enhanced bonding of subsequent layers, or can be capped to prevent corrosion. Alternatively, a controlled and limited production of surface oxide, nitride, or other suitable material can be put down as a passivation layer.

Shaping and Smoothing Heterogeneous Materials

In one application in accordance with the present invention, a heterogeneous material can be etched using the plasma. When a heterogeneous surface is etched, the resultant surface may not be as smooth as an etched homogeneous surface. This difference can be attributed to variable etch rates between heterogeneous grains, as well as preferential etching along grain boundaries. This effect, however, may be limited.

The chemistry in the plasma can be altered to favor deposition over removal, and a layer of the same material, or a different material, can be quickly deposited. To accomplish this, a suitable reactive chemical precursor can be used. For the deposition of amorphous SiO₂, for example, a range of chemical compounds containing silicon maybe suitable, including but not limited to silanes and SiO₂ particles. For the deposition of other materials, different chemical precursors can be used. Such a chemical precursor can be introduced in a solid, liquid, or gaseous form. Liquids can be aspirated into the plasma, and powders of solids can be nebulized and introduced with a gas.

This new layer maybe more amenable to the smoothing process. Back-etching of this deposited layer can allow the shaping of smooth surfaces on an originally rough and heterogeneous substrate. Alternatively, wet chemical etching can be used to remove surface damage on a conventionally polished part. The resulting rough surface then could be coated using the plasma jet and back-etched to achieve a smooth precision surface.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for shaping a surface of a workpiece, comprising:
moving a microwave-induced plasma torch over the surface of the workpiece; and
using reactive atom plasma processing to shape the surface of the workpiece with the discharge from the microwave-induced plasma torch.

2. A method according to claim 1, wherein:
using reactive plasma processing to shape the surface of the workpiece further comprises at least one of:
removing material from the surface of the workpiece; and
polishing the surface of the workpiece.

3. A method according to claim 1, wherein:
using reactive atom plasma processing to shape the surface of the workpiece occurs at atmospheric pressure.

4. A method according to claim 1, wherein:
using reactive atom plasma processing to shape the surface of the workpiece causes minimal or no damage to the workpiece underneath the surface.

5. A method according to claim 1, further comprising at least one of:
adding material to the surface of the workpiece with the discharge from the microwave-induced plasma torch;
altering the chemistry of the surface of the workpiece with the plasma; and
tuning a microwave cavity surrounding at least a portion of the microwave-induced plasma torch.

6. A method according to claim 1, further comprising:
directing a flow of process gas into the microwave-induced plasma torch.

7. A method according to claim 6, further comprising:
maintaining the flow of process gas between about 0.5 l/min and about 14 l/min.

8. A method according to claim 1, further comprising at least one of:
operating the microwave-induced plasma torch at a power between about 35 W and about 3 kW;
surrounding at least a portion of the microwave-induced plasma torch with a microwave cavity;
increasing the velocity of process gas using a helical insert in the microwave-induced plasma torch;
coupling energy to a microwave cavity surrounding at least a portion of the microwave-induced plasma torch;
coupling energy to a microwave cavity surrounding at least a portion of the microwave-induced plasma torch using a 2.45 GHz power source; and
shielding the microwave-induced plasma torch from the atmosphere using a gas sheath.

9. A method according to claim 1, further comprising at least one of:
moving the workpiece with respect to the microwave-induced plasma torch;
creating a reactive species in the plasma;
placing a precursor in a center tube of the microwave-induced plasma torch;
placing a precursor in the microwave-induced plasma torch and creating a reactive species in the plasma;
placing a precursor in the microwave-induced plasma torch;
controlling the mass flow of a precursor into the plasma; and
selecting a concentration of precursor to be introduced into a center tube of the microwave-induced plasma torch.

10. A method according to claim 1, further comprising at least one of:
introducing a plasma gas through an outer tube of the microwave-induced plasma torch; and
controlling the size of a discharge by selecting the inner diameter of an outer tube of the microwave-induced plasma torch.

11. A method according to claim 1, further comprising:
producing a volatile reaction on the surface of the workpiece.

12. A method according to claim 1, further comprising at least one of:
using a precursor solution to control the etch rate of the microwave-induced plasma torch; and
using a precursor to control the etch rate of the microwave-induced plasma torch, the precursor being any one of a solid, liquid, or gas.

13. A method for planarizing a surface of a workpiece, comprising:
moving a microwave-induced plasma torch over the surface of the workpiece;
removing material from the surface of the workpiece using a discharge from the microwave-induced plasma torch; and
using reactive atom plasma processing to redeposit the removed material on the surface of the workpiece.

14. A method according to claim 13, further comprising:
polishing the surface of the workpiece with the microwave-induced plasma torch.

15. A method according to claim 13, further comprising:
controlling the removal rate at which material is removed from the surface of the workpiece.

16. A method according to claim 13, further comprising:
controlling the redeposition rate at which material removed from the surface during processing is redeposited on the surface.

17. A method according to claim 13, further comprising at least one of:
depositing material on the surface of the workpiece using the microwave-induced plasma torch;
maintaining the temperature of the plasma from the microwave-induced plasma torch; and
altering the chemistry of the surface of the workpiece with the microwave-induced plasma torch.

18. A method according to claim 17, further comprising:
controlling the deposition rate at which material is deposited onto the surface of the workpiece.

19. A method for cleaning a surface, comprising:
moving a microwave-induced plasma torch with respect to a workpiece; and
using reactive atom plasma processing to deposit and remove material from the surface of the workpiece.

20. A method for redistributing a material on a surface, comprising:
moving a microwave-induced plasma torch with respect to the surface of a workpiece; and
using reactive atom plasma processing to deposit and redistribute material on the surface of the workpiece.
